(19) United States
(12) Patent Application Publication
(10) Pub. No.: US 2015/0272190 A1
(43) Pub. Date: Oct. 1, 2015

(54) Composition Prepared From Flax Seeds And Methods Of Their Use

(71) Applicant: International Dehydrated Foods, Inc., Springfield, MO (US)

(72) Inventors: Roger Dake, Springfield, MO (US); Nancy Lewis, Aurora, MO (US)

(21) Appl. No.: 14/674,870

(22) Filed: Mar. 31, 2015

Related U.S. Application Data
(60) Provisional application No. 61/973,676, filed on Apr. 1, 2014.

(51) Int. Cl. A23L 1/308; A23L 3/3472; A23D 9/007

(52) U.S. Cl. CPC A23L 1/308; A23D 9/007; A23L 3/3472; A23V 2002/00

(57) ABSTRACT

This disclosure relates to a process to make a water soluble extract of ground or milled flax seed and/or related by-products that is useful in numerous applications in a wide range of food or beverage products. The flax extract generated from the disclosed process has significant positive functional characteristics, including, for example, emulsion capacity, water binding, cohesive and adhesive properties, antioxidant capacity, and excipient capability.

### RELATED APPLICATION

This application claims priority to U.S. Patent application 61/973,676 filed Apr. 1, 2014, the entire content of which is hereby incorporated by reference into this application.

### BACKGROUND

1. Field of the Invention

This disclosure relates to a process for preparing an extract from flax seeds and the compositions prepared according to the disclosed process. The disclosure also pertains to methods of using the compositions in various products.

2. Description of Related Art

Flax seed (flaxseed) has become more and more popular in recent years, largely due to its potential health benefits. More and more food products have been made with flax seed and its derivatives.

Flax seed is rich in fat, protein and dietary fiber. An analysis of brown Canadian flax whole seed shows an average of 41% fat, 20% protein, 28% total dietary fiber, 7.7% moisture and 3.4% ash (the mineral-rich residue left after samples are burned). Flax provides a unique mix of fatty acids that are commercially valuable. For instance, polyunsaturated fatty acids, such as omega-3 fatty acid and linoleic acid are essential for human. Flax protein has similar amino acid profile as that of soybean protein and is believed to be one of the most nutritious among plant proteins.

Flax extracts have been prepared for various uses. However, existing methods are generally more focused on obtaining flax proteins or omega-3 fat. As a result, substantial amount of dietary fiber is lost in the process.

### SUMMARY

The disclosed instrumentalities advance the art by providing methods for preparing a flax extract that is enriched in soluble fiber. The disclosed methods and compositions allow for expanded use of flax seed in a broad range of products. According to this disclosure, a composition may be prepared from flax seeds by extracting select components from the seeds. In one embodiment, the flax seeds may be extracted by at least the following steps: (a) incubating (or cooking) a flax seed starting material in water at a temperature of 70° C. or higher, (b) separating water insoluble fraction from water soluble fraction, and (c) collecting the water soluble fraction to obtain the flax seed extract. For instance, the cooking temperature may be at 80° C., 90° C., 100° C., 110° C., 115, 120° C., 125° C., 130° C., or higher. Step (a) may last at least 30 minutes, one, two, three, four, five, six hours or longer. In another embodiment, Step (a) may be performed under pressure that is at least 15, 20, 25, 28, 29, 30 psi. For instance, when step (a) is conducted in a conventional pressure cooker that is set at 15 psi, the absolute pressure inside the cooker is 15 psi plus the normal atmospheric pressure at the location. At sea level, normal atmospheric pressure is about 15 psi. Therefore, at sea level, the absolute pressure in such a pressure cooker is 30 psi. This higher pressure helps the water achieve higher boiling point that is above 100° C.

Step (a) may be performed with water without any addition of organic solvent, acid or base. For purpose of this disclosure, “water” has a pH between 6 and 9, or between 6.5 and 8.5. The term “solution” may be used to refer to an acidic, basic or a pH-neutral homogeneous mixture of a solvent and one or more solutes.

The flax seed starting material may be milled or unmilled flax seed or fractions thereof, or it may be other plant parts obtained from flax. In one embodiment, certain enzymes may be used to facilitate the digestion of the flax seed starting material. For instance, cellulase, hemicellulase, xylanase, pectinase, betaglucanase may be used for this purpose. The enzymes may be prepared from microorganisms, such as Trichoderma or Aspergillus, which may include but are not limited to Trichoderma reesei, Trichoderma longibrachiatum, Aspergillus niger, among others. In one aspect, the enzyme is a food grade enzyme and is safe for human consumption.

In one embodiment, the disclosed composition may contain dietary fiber derived from the flax seeds. Naturally occurring dietary fiber from flax seeds contains both soluble fiber and insoluble fiber. In one aspect, the terms “soluble fiber” and “insoluble fiber” may be used to refer to fibers that are soluble or insoluble in a solution, respectively. In another aspect, the terms “soluble fiber” and “insoluble fiber” refer to fibers that are soluble or insoluble in water, respectively. In one aspect, the insoluble fiber may be selectively removed from the dietary fiber such that the final flax extract may contain less than 10%, 5%, 2%, 1%, 0.3%, 0.1% or 0% (w/w) of insoluble fiber. In another aspect, soluble fiber may make up at least 70%, 80%, 90%, 95%, 98%, 99% or 100% (w/w) of the total dietary fiber. In another aspect, the flax extract may contain at least 10%, 20%, or 30% of total dietary fiber. In another aspect, the flax extract may contain between 10%-30%, 10-20%, or 15-20% soluble fiber by weight of total solid. In another aspect, the weight ratio between soluble fiber and insoluble fiber is 30:1, 20:1 or 10:1.

In another embodiment, the flax extract may contain between 10% and 35% of total protein, or less than 20%, 15%, or 10% of total protein. In another aspect, the flax extract may contain less than 20% 15%, or 10% of total amino acids by weight.

The flax extract may also contain lignan, which is an important plant phenolic compound. In one aspect, the lignan is in a liquid dispersible form in the disclosed extract. In another aspect, the flax extract may contain 3%-5%, or 4%-5% (w/w) of lignan. In another aspect, the flax extract may contain less than 2%, 1% or 0.5% (w/w) of lignin.

In another embodiment, the flax extract disclosed herein may contain at least 1%, 2%, or 3% by weight of secoisolariciresinol diglucoside (SDG).

Majority of fats and oils are removed according to the disclosed process. In one embodiment, the amount of total fat is less than 10%, 6%, 4% or 2% or less by weight in the flax extract disclosed herein.

The disclosed composition may be used as a supplement in a variety of food, beverage or other products. One of the advantages of the composition prepared according to the disclosed methods is that the composition may be more functional and versatile than existing products. Due to its unique chemical composition and characteristics, the disclosed flax seed extract may act more efficiently as a main ingredient in a food product or in a beverage product, or it may act as a supplementary ingredient, which may include but not limited to, a binding agent in a meat product, a binding agent in a poultry product, a binding agent or thickener in canned and extruded pet foods and treats, a thickener in food and feed materials, a binder in protein and granola type bars, a flavor, an ingredient in flavor reactions, an emulsifier for baked product, a dough improver for baked product, a texture improver for baked product, a staling preventer for baked product, an ingredient to aid particulate affixation on baked goods, an antioxidant agent, a preserver of flavor, a lecithin replacer, a plasma replacer, a viscosity enhancer, a gelling agent, a gluten replacer, a foam stabilizer, an emulsion stabilizer, a natural volumetric bulking agent, a fixative agent, a humectant, a nutritional emulsifier for flax seed lipids, a carrier of spray dried fats and oils, a cohesive agent, or combination thereof.

In one embodiment, the flax extract may be used as a binder in protein bars, granola bars, energy bars, or other similar products. Keeping the various ingredients in these bar-typed products may be a challenge, especially when components having inherent binding properties are not present at a sufficiently high level or have been removed for other reasons. The flax extract disclosed herein is derived from natural plant sources and may be used as an substitute binder in making protein bars, granola bars, energy bars, and similar products.

The disclosed composition may have many characteristics and uses that are desirable in the food and beverage industries, among others. For instance, it may act as a carrier of spray dried fats and oils that include omega-3 fatty acids. In another aspect, the disclosed composition may be used as a thickener, and may replace other food ingredients that are less desirable. In another aspect, the disclosed composition may be used in a food or beverage product which may include but not limited to a meat product, a poultry product, a canned food product, a pet food product, a baked food product, a animal feed product, a granola bar, a protein bar, an energy bar, a nutritional bar, a nutritional beverage, an energy beverage, a salad dressing, a gravy product, a sauce, a stew product, a chili product, or combination thereof.

In another embodiment, the disclosed composition may be used to replace phosphates in a marinade, a meat product, a poultry product, a beverage product, a canned food product, a pet food product, a baked food product, an animal feed product, a granola bar, a protein bar, an energy bar, a nutritional bar, a nutritional beverage, or combination thereof.

In another embodiment, this disclosure relates to a process for preparing a water soluble extract of ground or milled flax seed and/or related by-products that is useful in numerous applications in a wide range of food products. The extract of this composition has significant positive functional characteristics in emulsion capacity, water binding, cohesive properties, antioxidant capacity, and excipient capability. This invention enables the capture of value from by-products of flax seed processing as well as the seed itself. The composition may be used in its initial liquid extract state at lower concentration, or may be concentrated for sale under refrigeration, or may be dried by processes currently available in the art.

In another embodiment, the disclosed process allows the capture of value from by-products of flax processing or flax seed processing as well as from the seed itself. The composition may be used in its initial liquid extract state at lower concentration, or may be concentrated for sale under refrigeration, or may be dried by conventional processes.

The disclosed flax extract may have anti-inflammatory properties and a number of other health benefits. For example, it may help control, modulate, or reduce inflammation in a mammal or human.

### DETAILED DESCRIPTION

The scientific name of flax is Linum usitatissimum of the family Linaceae. Flax and its parts have been widely used to make edible oil, as a nutritional supplement, and as an ingredient in many other products. Although the composition of flax seeds may vary with genetic background, most flax seeds contain substantial amount of fat (lipid), protein and fiber, along with significant amount of other ingredients, such as plant hormones, antioxidants, among others.

Dietary fiber may act as a bulking agent in the digestive system and has a number of health benefits. Based on their relative solubility in water, the dietary fibers in flax seeds can be classified into two categories: soluble fiber and insoluble fiber. Existing processes for extracting flax seed are mainly focused on achieving higher protein yields. As a result, the majority of the dietary fiber is lost in the process. U.S. Pat. No. 5,925,401 issued to Kankaanpaa-Anttila et al. (the '401 patent hereinafter) disclosed a process for producing a product containing flax proteins and flax mucilage. According to the '401 patent, flax seeds are cold and/or hot pressed and are extracted with an alkali solution. The alkali extract is then treated with acid and a lower alkanol for producing a precipitate containing proteins and mucilage. According to this process, although relatively high level of protein is obtained, substantial amount of dietary fiber, especially the portion containing soluble fiber, is lost. Rather than using alkali solution, acids and lower alkanols, the present disclosure employs a different solvent, namely, water, to extract flax seed. It is found that substantial amount of soluble fiber is recovered in water after cooking the flax seed under a temperature as high as 100° C., 110° C., 120° C. or higher under pressure that is about 15 psi higher than normal atmospheric pressure.

Flax seed also contain significant amount of phenolics. Phenolics are plant compounds that perform different functions in plants. Many of these plant compounds have antioxidant effects when used in humans. At least three types of phenolics exist in flax, these include, for example, phenolic acids, flavonoids, and lignans. Lignans are bioactive, non-nutrient, non-caloric phenolic compounds that are rich in a number of plants. See e.g., Peterson, J. et al., Dietary lignans: physiology and potential for cardiovascular disease risk reduction. Nutr Rev. October 2010; 68(10): 571-603. The various components, such as fiber and phenolics, may have anti-inflammatory effects, and may help reduce the risk of heart disease, diabetes, cancer, obesity, among other diseases. In one aspect, the instant disclosure provides a composition containing lignan in a dispersible form, e.g., as a liquid.

Taken together, the instant disclosure provides an improved process for preparing flax seed extract enriched in soluble fiber, phenolics, among others. In one embodiment, the extract may be used as an ingredient in food or beverage products.

In another embodiment, the disclosed extract may be used as a binding agent in a meat or poultry product formulations. In another embodiment, the disclosed extract may be used as a binding agent or thickener in canned and extruded pet foods and treats.

In another embodiment, the disclosed extract may be used as a thickener in food or feed materials.

In another embodiment, the disclosed extract may be used as flavors or in flavor reactions.

In another embodiment, the disclosed extract may be used in baked goods as emulsifier, dough improver, texture improver, or staling preventer. In another embodiment, the disclosed extract may be used to aid in particulate affixation on baked goods.

In another embodiment, the disclosed extract may be used to preserve healthful lipids of value such as omega-3 polyunsaturated and monounsaturated fatty acids, as well as to prevent development of rancidity or off flavors, and to preserve flavor integrity.

In another embodiment, the disclosed extract may be used to prepare granola, protein, energy, and other nutritional bars as well as nutritional beverages.

In another embodiment, the disclosed extract may be used as a lecithin replacer.

In another embodiment, the disclosed extract may be used in salad dressings as an emulsifier, thickener, or for flavoring.

In another embodiment, the disclosed extract may be used in gravies, sauces, stews, and chili products to prevent fat separation.

In another embodiment, the disclosed extract may be used as a plasma replacer in canned pet foods.

In another embodiment, the disclosed extract may be used as a viscosity enhancer, gelling agent, gluten replacer, foam stabilizer, emulsion stabilizer, or natural volumetric bulking agent.

In another embodiment, the disclosed extract may be used as a fixative agent to adhere compounds, flavors, or mixtures to the surface of dry food products and pet food kibbles.

In another embodiment, the disclosed extract may be used as a humectant.

In another embodiment, the disclosed extract may be used for inclusion in egg replacement formulations.

In another embodiment, the disclosed extract may be used in products containing collagen proteins, poultry broths, and other ingredients in compositions for health applications.

In another embodiment, the disclosed extract may be used as a nutritional emulsifier in human or animal diets to improve fat digestibility and thus improve energy efficiency, or as a nutritional emulsifier for flax seed lipids.

It is to be noted that, as used in this specification and the claims, the singular forms “a,” “an,” and “the” include plural referents unless the context clearly dictates otherwise. Thus, for example, reference to “a device” may include reference to one device, as well as two or more devices, unless the context clearly limits the reference to one device.

The terms “between” and “at least” as used herein are inclusive. For example, a range of “between 5 and 10” means any amount equal to or greater than 5 but equal to or smaller than 10.

The terms “flax seed” and “flaxseed” may be used interchangeably in this disclosure and both refer to the seed(s) of flax.

Unless otherwise specified, the percentage of certain component in a composition is by weight of total solid.

Various commercially available products may have been described or used in this disclosure. It is to be recognized that these products are cited for purpose of illustration only. Certain physical and/or chemical properties and composition of the products may be modified without departing from the spirit of the present disclosure. One of ordinary skill in the art may appreciate that under certain circumstances, it may be more desirable or more convenient to alter the physical and/or chemical characteristics or composition of one or more of these products in order to achieve the same or similar objectives as taught by this disclosure.

### EXAMPLES

The following examples are provided to illustrate the present invention, but are not intended to be limiting. The reagents, materials and instruments are presented as typical components, and various substitutions or modifications may be made in view of the foregoing disclosure by one of skills in the art without departing from the principle and spirit of the present invention.

### Example 1

### Preparation of Flax Seed Extract

Whole flax seeds were milled to a coarse flour or meal. 9 parts of water was then added to one part of this flax seed meal, and the mixture was cooked for 6 hours at about 250° F. (about 121° C.) in a stove top pressure cooker set at 15 psi. Thus, the absolute pressure inside the cooker was atmospheric pressure plus 15 psi. The suspension was cooled to about 180° F. (about 82° C.), and was passed successively through 16, 25, and 30 mesh sieves to separate off solid pieces. The liquid thus obtained was strained through fine nylon mesh cloth. The liquid that passed through the fine nylon mesh was concentrated on stove top in a sauce pan. A top layer of fat was skimmed off. As the liquid began thickening, the product was chilled at 11% solids and stored for later use.

The flax seed extract prepared according to this high temperature water extraction process was subject to a chemical analysis, and the results showed that it contained less than 35% (w/w) protein by weight of total solid. Further analysis also showed that the flax seed extract contained about 19.5% (w/w) of soluble fiber and only about 0.3% (w/w) of insoluble fiber by weight of total solid. By contrast, parallel analysis of a commercial flax seed product that was not prepared with the high temperature water extraction process as disclosed herein contained about 11.5% (w/w) of soluble fiber and about 21.3% (w/w) of insoluble fiber by weight of total solid.

A portion of the flax seed extract was dried on a drum dryer making a powdered flax seed extract product that was used in the following examples.

The disclosed compositions may be prepared and/or distributed in a concentrated form or a diluted form. A concentrate may be dissolved or dispersed in a solvent to form a reconstituted solution.

### Example 2

### Preparation of Beef Fat and Flax Seed Extract Mix

A portion of the extract (11% solids) was used to make a dried beef fat ingredient as described below. 267 grams of flax seed extract was heated to 160° F. and mixed in a Silverson Model L5M-A Mixer. While mixing, 70 grams of melted, warm beef fat was added. The mixture was then blended for 10 minutes at 10,000 rpm, which results in a very stable emulsion. This emulsion contained approximately 30% solids. This emulsion was dried in a convection oven at 200° F. to dryness. This dry beef fat with flax seed extract product was approximately 70 percent fat and 30 percent flax seed extract.

Another portion of the flax seed extract was used to make a similar dried beef fat product at 80% fat and 20% flax seed extract as described below:

20 grams of dried flax seed extract was mixed in 150 grams of water, and then 80 grams of beef fat was mixed in and emulsified in the Silverson Mixer for 10 minutes at 10,000 rpm resulting in a stable liquid emulsion with 40% solids content. This was dried in a convection oven as above resulting in a dried beef fat product usable as an ingredient in food product applications.

### Example 3

### Preparation of Canola Oil and Flax Seed Extract Mix

Following the process described in the previous Examples, except canola oil instead of beef fat was used. Canola oil emulsified very well with the flax seed extract.

### Example 4

### Antioxidant Effect of Flax Seed Extract

Dried Flax Seed Extract was blended into raw mechanically separated chicken (MSC) at level of 2%, 5%, and 10%. The MSC with Flax Seed Extract was cooked for 10 minutes to a temperature of 210° F. The cooked product was analyzed in the laboratory for oxidative stability against control MSC that did not receive the Flax Seed Extract. Fat from the MSC samples was analyzed for Oxidative Stability Index (OSI). The data in Table 1 show that the flax seed extract had an antioxidant effect on the product.

TABLE 1
Antioxidant effect of flax seed extract

| | OSI Hours |
|---|---|
| 2% flax seed extract | 3.6 |
| 5% flax seed extract | 5.0 |
| Control no flax seed extract | 2.5 |

### REFERENCES

All references listed below and those publications, patents, patent applications cited throughout this disclosure are hereby incorporated expressly into this disclosure as if fully reproduced herein.
Peterson, J. et al., Dietary lignans: physiology and potential for cardiovascular disease risk reduction. Nutr Rev. October 2010; 68(10): 571-603.

We claim:

1. A composition prepared from flax seed, said composition comprising dietary fiber derived from said flax seed, wherein said dietary fiber comprises at least 80% (w/w) soluble fiber.

2. The composition of claim 1 further comprising insoluble fiber, wherein the weight ratio between said soluble fiber and said insoluble fiber in said composition is greater than 20:1.

3. The composition of claim 1, wherein said composition comprises 10%-35% of total protein by weight.

4. The composition of claim 3, wherein said composition comprises less than 20% of total protein by weight.

5. The composition of claim 1, wherein said composition comprises less than 20% of total amino acids by weight.

6. The composition of claim 1, wherein said composition comprises 10%-30% of soluble fiber by weight.

7. The composition of claim 6, wherein said composition comprises more than 15% of soluble fiber by weight.

8. The composition of claim 1, wherein said composition comprises less than 1% of insoluble fiber by weight.

9. The composition of claim 1, wherein said composition further comprises 3%-5% (w/w) of lignan and less than 1% (w/w) lignin, wherein said lignan is in a liquid dispersible form.

10. The composition of claim 1, wherein said composition further comprises secoisolariciresinol diglucoside (SDG), the amount of said SDG in said composition being greater than 2% by weight.

11. The composition of claim 1, wherein the amount of total fat in said composition is less than 10% by weight.

12. The composition of claim 11, wherein the amount of total fat is between 4% and 6% by weight.

13. The composition of claim 1, wherein said composition has anti-inflammatory properties.

14. The composition of claim 1, wherein the flax seed extract is prepared by a process comprising:
(a) cooking a flax seed starting material in water,
(b) separating water insoluble fraction from water soluble fraction, and
(c) collecting the water soluble fraction to obtain the flax seed extract,
wherein the flax seed starting material is milled or unmilled flax seed or fractions thereof, and wherein no alkali or acid is used in step (a).

15. A process for making a flax seed extract, comprising:
(a) cooking a flax seed starting material in water with no use of alkali or acid,
(b) separating water insoluble fraction from water soluble fraction, and
(c) collecting the water soluble fraction to obtain the flax seed extract,
wherein the flax seed starting material is milled or unmilled flax seed or fractions thereof.

16. The process of claim 15, wherein no organic solvent is used in said process.

17. The process of claim 15, wherein at least one enzyme is used in step (a), said at least one enzyme being a member selected from the group consisting of cellulase, hemicellulase, xylanase, betaglucanase, and pectinase.

18. The process of claim 17, wherein said enzyme is a food grade enzyme.

19. The process of claim 15, wherein said flax seed starting material is cooked at a temperature of 70° C. or higher for at least 3 hours.

20. The process of claim 15, wherein the flax seed starting material is cooked at a temperature of 115° C. or higher for at least 3 hours.

21. The process of claim 20, wherein the flax seed starting material is cooked under pressure that is at least 20 psi.

22. The process of claim 15, wherein said flax seed extract comprises soluble fiber and insoluble fiber, and wherein the ratio between said soluble fiber and said insoluble fiber is greater than 20:1 (w/w).

23. A method of using a flax seed extract comprising dietary fiber derived from said flax seed, said dietary fiber comprising at least 80% (w/w) soluble fiber, wherein said flax seed extract is used as an agent selected from the group consisting of an ingredient in a food product, an ingredient in a beverage product, a binding agent in a meat product, a binding agent in a poultry product, a binding agent or thickener in canned and extruded pet foods and treats, a thickener in food and feed materials, a binding agent in protein bars, a binding agent in granola bars, a binding agent in energy bars, a flavor, an ingredient in flavor reactions, an emulsifier for baked product, a dough improver for baked product, a texture improver for baked product, a staling preventer for baked product, an ingredient to aid particulate affixation on baked goods, an antioxidant agent, a preserver of flavor, a lecithin replacer, a plasma replacer, a viscosity enhancer, a gelling agent, a gluten replacer, a foam stabilizer, an emulsion stabilizer, a natural volumetric bulking agent, a fixative agent, a humectant, a nutritional emulsifier for flax seed lipids, a carrier of spray dried fats and oils, a cohesive agent, and combination thereof.

24. The method of claim 23, wherein said flax seed extract is used in a food or beverage product selected from the group consisting of a meat product, a poultry product, a canned food product, a pet food product, a baked food product, a animal feed product, a granola bar, a protein bar, an energy bar, a nutritional bar, a nutritional beverage, an energy beverage, a salad dressing, a gravy product, a sauce, a stew product, a chili product, and combination thereof.

25. The method of claim 23, wherein said flax seed extract has anti-inflammatory properties.

26. The method of claim 23, wherein said flax seed extract is used to replace phosphates in a product selected from the group consisting of a marinade, a meat product, a poultry product, a beverage product, a canned food product, a pet food product, a baked food product, an animal feed product, a granola bar, a protein bar, an energy bar, a nutritional bar, a nutritional beverage, and combination thereof.
